(19) United States
(12) Patent Application Publication
(10) Pub. No.: US 2007/0230717 A1
(43) Pub. Date: Oct. 4, 2007

(54) CONDENSER MICROPHONE CIRCUIT

(75) Inventor: Hiroshi Akino, Machida-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Audio-Technica, Machida-shi (JP)

(21) Appl. No.: 11/688,477

(22) Filed: Mar. 20, 2007

(30) Foreign Application Priority Data
Mar. 31, 2006 (JP) 2006-096698

(51) Int. Cl. H04R 3/00; H04R 25/00

(52) U.S. Cl. 381/113; 381/172

(57) ABSTRACT

In a condenser microphone which selectively uses a phantom power supply and a built-in battery power supply, and which switches load resistance elements of an impedance converter corresponding to a selected power supply, a noise due to the high frequencies is prevented from occurring even if a cellular phone or the like is used in the vicinity. The condenser microphone includes: a condenser type electro-acoustic transducer element; an impedance converter that converts an output impedance of the electro-acoustic transducer element; load resistance elements of the impedance converter; a phantom power supply and a built-in battery power supply for operating the impedance converter; a switch that switches the values of the load resistance between at the time of using the phantom power supply and at the time of using the built-in battery power supply, wherein the switch is an optical switch that turns on/off optical coupling. The optical switch is switched so that the value of the load resistance is larger at the time of using the phantom power supply than at the time of using the built-in battery power supply.

### BACKGROUND OF THE INVENTION

1. Field of the Invention

The present invention relates to a condenser microphone circuit, and in particular to a condenser microphone circuit capable of operating by switching a phantom power supply and a battery, which is a built-in power supply.

2. Related Background of the Invention

In a condenser microphone, an impedance converter using an FET (Field Effect Transistor, and hereinafter the same) or the like is used because the impedance of a condenser microphone unit, which is an electro-acoustic transducer, is high. A power supply is required to operate this impedance converter. The power supplies for the condenser microphone include a power supply that is built-in within a microphone, i.e., typically a battery, and a mixer or a phantom power supply for supplying power from the outside. The above-described phantom power source is supplied to a microphone via an output cord of the microphone as specified in Standard of Electronic Industries Association of Japan (EIAJ), RC-8162A “Power Supply Method for Microphone.” The power supply circuit types of the phantom power supply include a resistor divider T-coupling type, a center tap transformer type, and the like, however, the detailed descriptions thereof are omitted because the power supply circuit type itself of the phantom power supply does not have a direct relationship with the present invention.

A relatively inexpensive condenser microphone for general use or for home use is operated only with a built-in battery power supply. In contrast, in the case of a business-use condenser microphone, if it is operated only with a battery as a built-in power supply, when the battery is exhausted, it may not be used continuously and thus the reliability can not be maintained. For this reason, a phantom power supply supplied from the outside is used as a main power supply, and the built-in power supply is used as an auxiliary power supply if there is a problem with the phantom power supply. As for the built-in battery power supply, a size AA dry cell is usually used for easy availability and the voltage thereof is approximately 1.5 V.

In the condenser microphone capable of selectively using a phantom power supply and a built-in battery power supply, if the circuit is designed so as to obtain sufficiently large amplitude of an output signal when using the phantom power supply, the circuit will not operate when being operated only with the built-in battery power supply. On the contrary, if the circuit is designed so as to operate optimally at a voltage of the built-in battery power supply, e.g., at 1.5V, sufficiently large amplitude of the output signal may not be obtained in spite of an increased power supply voltage when using the phantom power supply. Consequently, it is desirable that when using the built-in battery power supply an output signal level corresponding to the supply voltage thereof may be obtained, and when using the phantom power supply a large signal output level corresponding to the supply voltage thereof may be obtained.

The applicant filed a patent earlier concerning a condenser microphone wherein other than an FET, which is an impedance conversion element of the condenser microphone and which is used for signaling, a switching FET is provided and a source resistance of a signaling FET is switched by means of the switching FET in response to the switching of a phantom power supply and a built-in battery power supply. When using the built-in battery power supply the source resistance value of the signaling FET is reduced, and when using the phantom power supply the above-described source resistance value is increased, thereby making the amplitude of a signal voltage larger than when using the built-in battery power supply, so that the maximum permissible sound pressure level is increased (see Patent document 1).

FIG. 2 shows an example of a condenser microphone circuit that incorporates therein the same technical concept as that of the invention described in Patent Document 1. Hereinafter, this circuit example will be described schematically. In FIG. 2, reference numeral 5 denotes a built-in battery power supply, 6 denotes a condenser type electro-acoustic transducer element, 7 denotes a power supply line, 8 denotes a buffer amplifier, reference symbol Q01 denotes a signaling FET that is an impedance conversion element, Q02 denotes a switching FET, and TRS denotes a transformer, respectively. As for a secondary winding of the transformer TRS, one end thereof is connected to a hot side terminal pin 2 and the other end is connected to a cold side terminal pin 3. The above-described terminal pin 2 and terminal pin 3 are connected to an output cord via a three pin type connector that complies with the above-described EIAJ Standard, for example, and another terminal pin 1 is connected to an earth line of the microphone circuit and is connected to a shielded wire of the output cord via the connector. The secondary winding of the transformer TRS has a center tap, which is connected to a gate of the switching FET Q02 via a constant current diode D04 and which is also connected to a power supply line 7 via the constant current diode D04 and a backflow preventing diode D03 in series. A positive terminal of a built-in battery power supply 5 is connected to the power supply line 7 via a backflow preventing diode D02.

The above-described three pin type connector is configured such that it is detachably connected to a power supply socket (not shown) of the phantom power supply so that the phantom power supply may be connected between two terminal pins 2 and 3. If the phantom power supply is connected in this way, the phantom power source is supplied from the center tap of the secondary winding of the transformer TRS to the power supply line 7 via the constant current diode D04 and the backflow preventing diode D03 in series, and a constant voltage is also applied to a gate of the switching FET Q02 through the constant current diode D04. The switching FET Q02 is a P-type junction FET.

Between the power supply line 7 and the earth line, the signaling FET Q01 and resistance elements R01 and R02 are connected in series. In other words, a source of the FET Q01 is connected to the power supply line 7, and a drain of the FET Q01 is connected to the earth line via the resistance elements R01 and R02 connected in series. The electro-acoustic transducer element 6 is connected between a gate of the FET Q01 and the earth line. The resistance elements R01 and R02 are the load resistance elements of the signaling FET Q01, and a connection point between these resistance elements R01 and R02 is connected to a source of the switching FET Q02. A drain of the switching FET Q02 is connected to the earth line. An output signal of the signaling FET Q01 is input to the buffer amplifier 8 that also serves as an impedance conversion circuit, an output of the buffer amplifier 8 is connected to one end of a primary winding of the transformer TRS, and the other end of the primary winding is connected to the earth line.

In the above-described circuit configuration, when using the built-in battery power supply 5, since the gate potential of the switching FET Q02 is set to 0 V, the FET Q02 is turned ON to short-circuit the load resistance element R02 and thus the load resistance of the signaling FET Q01 is only the resistance element R01, so that the load resistance value will decrease. This allows for the operation adapted to the voltage of the built-in battery power supply 5. On the other hand, when the phantom power supply is used, the phantom power supply is connected to the gate of FET Q02 via the constant current diode D04 and thus a terminal voltage of the constant current diode D04 is applied to the gate of FET Q02, so that the FET Q02 is turned off. Consequently, the load resistance of the signaling FET Q01 is set to a value of the resistance element R01 plus the resistance element R02, so that the power supply voltage to operate the FET Q01 constituting an impedance converter, can be increased to increase the amplitude of a signal voltage, thereby allowing the maximum permissible input sound pressure level to be increased.

In addition, as described hereinafter, the present invention is characterized in that a Photo-MOS relay is employed in switching the load resistance elements of the impedance conversion circuit when the phantom power supply and built-in battery power supply are used selectively. As a well-known example, in which the Photo-MOS relay or the like is employed in a condenser microphone, there is a microphone device of an explosion-proof structure, the microphone device including: a microphone and microphone connection box installed in an explosion hazardous area; and a barrier unit installed in a non-explosion hazardous area, wherein the barrier unit includes a photo coupler, and a sound output of the microphone sent via the microphone connection box is inputted to a light emitting diode at an input side of the photo coupler, so that the sound signal is sent from a photo-transistor at an output side of the photo coupler (e.g., see Patent Document 2). The invention described in Patent Document 2 provides an explosion-proof structure by optically coupling the explosion hazardous area with the non-explosion hazardous area, and is listed as an example using the Photo-MOS relay or the like for the condenser microphone.

### [Patent Document 1] Japanese Utility Model Application A-6-52300

### [Patent document 2] Japanese Utility Model Application B-5-28877

### SUMMARY OF THE INVENTION

### Problem to be Solved by the Invention

According to the invention of Patent Document 1, a desired objective can be achieved as described above. However, as apparent from the circuit configuration shown in FIG. 2, a voltage applied to a gate of a switching FET Q02 when using a phantom power supply is supplied from the vicinity of an output circuit of the microphone, more specifically from a secondary winding of a transformer TRS connected to terminal pins 2 and 3. A microphone code is connected to the output circuit of the microphone. Since a high frequency current is likely to penetrate the microphone code from the outside, the high frequency current penetrates the above-described output circuit from the microphone code. Since this high frequency current is applied to the gate of the switching FET Q02, there is a problem that this current is detected to make a noise. In particular, as cellular phones have been widely spreading like in recent years, a cellular phone is used more often in the vicinity of the microphone, thus causing a serious problem that the high frequencies emitted from the cellular phone cause a noise in the condenser microphone.

The present invention has been made to dissolve such a problem in the conventional art, and is intended to provide, in a condenser microphone whose circuit is configured so as to use a phantom power supply and a built-in battery power supply selectively and so as to switch the load resistance elements of an impedance converter corresponding to a selected power supply, a condenser microphone circuit capable of preventing a noise due to the high frequencies from occurring even if a cellular phone or the like is used in the vicinity of the microphone.

### Means for Solving the Problems

A condenser microphone circuit according to the present invention, includes a condenser type electro-acoustic transducer element; an impedance converter that converts an output impedance of the electro-acoustic transducer element; a load resistance of the impedance converter; a phantom power supply and a built-in battery power supply for operating the impedance converter; a switch that switches the values of the above-described load resistance between at the time of using the phantom power supply and at the time of using built-in battery power supply, wherein the above-described switch is an optical switch that turns on/off optical coupling.

The optical switch is switched so that the value of the load resistance is larger when using the phantom power supply than when using the built-in battery power supply.

It is preferable that the optical switch be a Photo-MOS relay and the phantom power supply be supplied to a light emitting element that constitutes a primary side of the Photo-MOS relay.

It is more preferable that the light emitting element of the Photo-MOS relay be a light emitting diode and that the phantom supply be supplied to the microphone circuit via the light emitting diode.

### Effects of the Invention

A switch switches the values of the load resistance of the impedance converter so that the impedance converter may function effectively corresponding to a supply voltage when using the phantom power supply and a supply voltage when using the built-in battery power supply. Since the switch is an optical switch for turning on/off optical coupling relationship and cuts off an electrical and electromagnetic coupling, a high frequency current attempting to penetrate via the phantom power supply line is cut off by means of the optical switch, so that the high frequency current may not reach the impedance converter. As a result, the high frequency current is not detected to make a noise at the impedance converter.

When a microphone circuit is configured such that an optical switch is a Photo-MOS relay, and a light emitting element that constitutes the primary side of the Photo-MOS relay is a light emitting diode, and the phantom power supply is supplied to the microphone circuit via this light emitting diode, the light emitting diode serves also as a backflow preventing device when using the built-in battery power supply, so that it is not necessary to provide the backflow preventing device as a separate component.

### BRIEF DESCRIPTION OF THE DRAWINGS

FIG. 1 is a circuit diagram showing an embodiment of a condenser microphone circuit according to the present invention.

FIG. 2 is a circuit diagram showing an example of a conventional condenser microphone circuit.

### DESCRIPTION OF THE PREFERRED EMBODIMENT

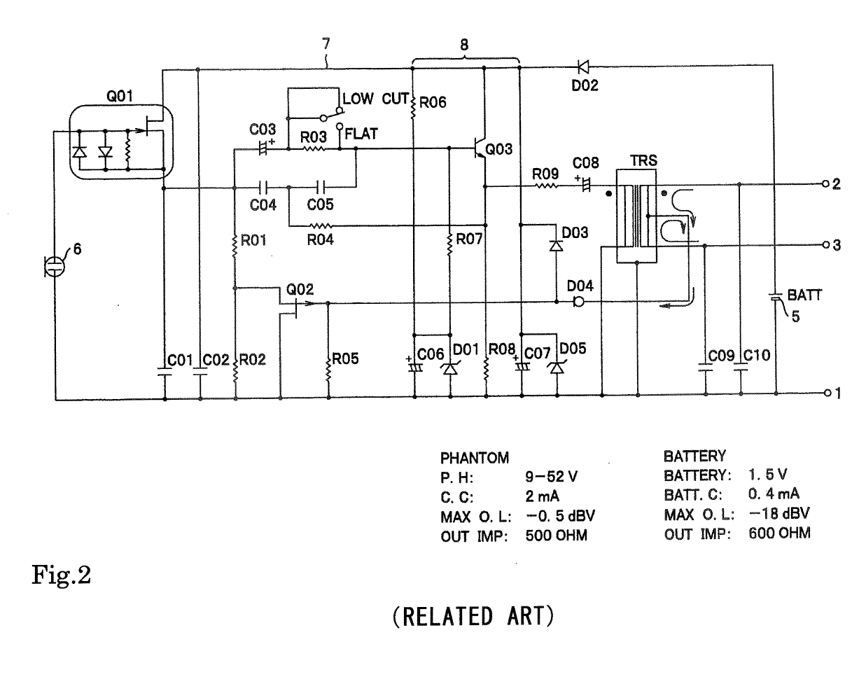

Hereinafter, an embodiment of a condenser microphone circuit according to the present invention will be described with reference to the drawings. The same reference numerals and symbols are given to the same components as those of the conventional example shown in FIG. 2.

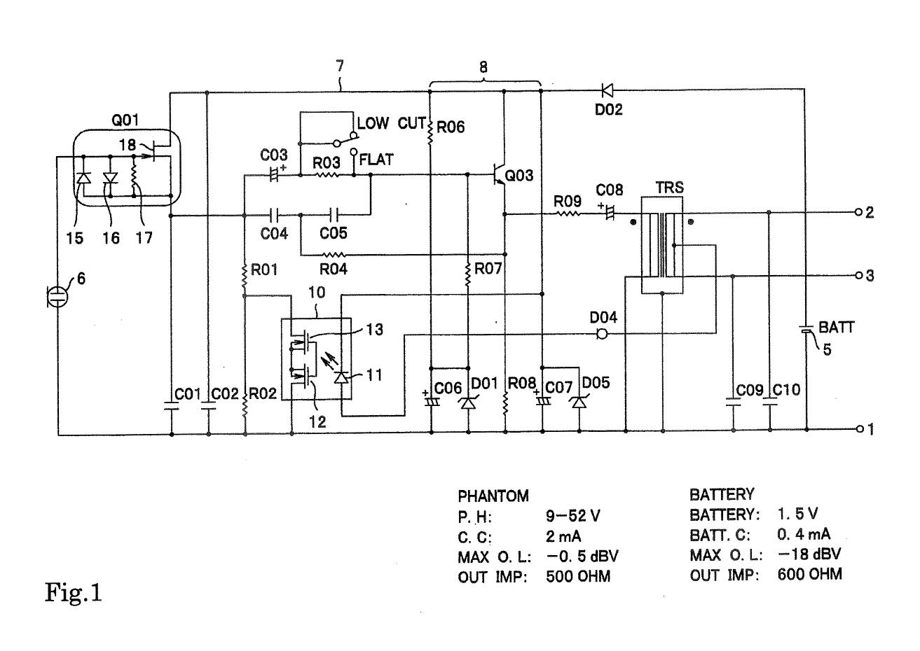

In FIG. 1, reference numeral 5 denotes a built-in battery power supply, 6 denotes a condenser type electro-acoustic transducer element, 7 denotes a power supply line, 8 denotes a buffer amplifier, 10 denotes an optical switch, reference symbol Q01 denotes an impedance conversion element, and TRS denotes a transformer, respectively. As for a secondary winding of the transformer TRS, one end is connected to a hot side terminal pin 2, and the other end is connected to a cold side terminal pin 3. The terminal pin 2 and terminal pin 3 are connected to an output cord via a three pin type connector that complies with the EIAJ Standard, for example, and another terminal pin 1 is connected to the earth line of the microphone circuit and is connected to the shielded wire of the output cord via the connector. The secondary winding of the transformer TRS has a center tap, and this center tap is connected to a primary side of an optical switch 10 via the constant current diode D04. The positive terminal of the built-in battery power supply 5 is connected to the power supply line 7 via the backflow preventing diode D02, and the negative terminal of the built-in battery power supply 5 is connected to the earth line.

As the optical switch 10, a Photo-MOS relay is used in the embodiment shown in FIG. 1. As the Photo-MOS relay, for example, TLP4176G made by Toshiba Corp. may be used. The Photo-MOS relay has a light emitting diode (hereinafter, referred to as an “LED”) 11 at the primary side (input side), and has a photodetector element consisting of two MOSFETs 12 and 13 that receive a beam of light emitted from an LED 11, at a secondary side (output side). In the two MOSFETs 12 and 13, the sources thereof are connected to each other and the respective drains are connected individually to an output terminal. In the two MOSFETs 12 and 13, the gates thereof are connected to each other, and when not receiving a beam of light, the two MOSFETs 12 and 13 are in an ON state in which the path between drains of the both MOSFETs 12 and 13, the drains being the output terminals of the Photo-MOS relay, is closed (the resistance value is nearly zero). By receiving a beam of light, the MOSFETs 12 and 13 are in an OFF state in which the path between the drains thereof is open (the resistance value is high). The center tap of the secondary winding of the transformer TRS is connected to an anode side of the LED 11 of the optical switch 10 via the above-described constant current diode D04, and a cathode side of the LED 11 is connected to the power supply line 7 of the microphone circuit.

The above-described three pin type connector is detachably connected to the power supply socket (not shown) of the phantom power supply, so that the phantom power supply can be connected between the two terminal pins 2 and 3. When the phantom power supply is connected in such a configuration, the phantom power supply is supplied to the power supply line 7 from the center tap of the secondary winding of the transformer TRS via the constant current diode D04 and the LED 11 of the optical switch 10 in series. That is, the phantom power supply is supplied to the power supply line 7 via the constant current diode D04 and the LED 11, and thus a power supply of a constant voltage is supplied to the power supply line 7 by means of the constant current diode D04. Moreover, the LED 11 of the optical switch 10 also serves as a backflow preventing diode that prevents a current from the battery 5 from flowing backwards to the phantom power supply circuit when using the built-in battery power supply 5.

Between the power supply line 7 and the earth line, an FET 18, which is a basic part of the impedance conversion element Q01, the resistance element R01 and the resistance element R02 are connected in series. More specifically, a source of the FET 18 is connected to the power supply line 7 and a drain of the FET 18 is connected to the earth line via the resistance elements R01 and R02 in series. The electro-acoustic transducer element 6 is connected between a gate of the FET 18 of the impedance conversion element Q01 and the earth line. The electro-acoustic transducer element 6 is the transducer of a condenser structure that includes as its main components a diaphragm and a fixed pole placed oppositely with a small gap from the diaphragm via a spacer therebetween. The resistance elements R01 and R02 are the load resistance elements of the impedance conversion element Q01, and the connection point between these resistance elements R01 and R02 is connected to a drain of an FET 13 that is one of the FETs constituting the secondary side of the optical switch 10. A drain of FET 12 that is the other FET constituting the secondary side of the optical switch 10 is connected to the earth line.

The impedance conversion element Q01 includes as its main component the FET 18, and includes protection diodes 15 and 16 that are connected mutually in parallel and a resistance element 17 between the gate and source of the FET 18. As the impedance conversion element Q01, an integrated circuit type is preferably used. The protection diodes 15 and 16 are mutually oppositely connected. The impedance conversion element Q01 does not require an external high resistance element, and the FET 18 is driven with zero bias. An output signal of the impedance conversion element Q01 is input to the base of a transistor Q03 of a buffer amplifier 8 that includes as its main component the transistor Q03. The buffer amplifier 8 serves also as the impedance conversion circuit, and the output of the buffer amplifier 8, specifically a terminal voltage of a resistance element R08 connected between an emitter of the above-described transistor Q03 and the earth line, is input to one end of the primary winding of the transformer TRS. The other end of the primary winding of the transformer TRS is connected to the earth line.

Between the power supply line 7 and the earth line, a constant voltage Zener diode D05 and a capacitor C07 are connected in parallel to constitute a regulated power supply circuit. A resistance element R07 is a bias resistance element connected to the base of the transistor Q03, and D01 is a similar bias Zener diode that is connected to the bias resistance element R07 in series.

Next, the operation of the above-described embodiment will be described. Now, assume that this circuit is operating only with the built-in battery power supply 5. Since a current from the built-in battery power supply 5 does not flow into the LED 11 at the input side of the optical switch 10, the LED 11 is not lit and thus the two FETs 12 and 13 at the output side of the optical switch 10 will be in an electrically closed state, i.e., in a short-circuited state. Consequently, the resistance element R02 is short-circuited, the load resistance of the impedance converter Q01 is only the resistance element R01, and thus the value of the load resistance decreases to be a load resistance value suitable for driving by the low voltage built-in battery power supply 5.

Next, when the phantom power supply is connected between the two terminal pins 2 and 3 by connecting the above-described three pin type connector to the non-illustrated power supply socket of the phantom power supply, a current flows from the center tap of the secondary winding of the transformer TRS to the power supply line 7 via the constant current diode D04 and the LED 11 of the optical switch 10, thereby supplying the phantom power supply to the power supply line 7. This current flow lights up the above-described LED 11, and a beam of light emitted from the LED 11 is received at the two FETs 12 and 13, so that the two FETs 12 and 13 will be in a cut off state, i.e., in a state that the switch is open. As a result, the load resistance of the impedance converter Q01 is set to a value of the resistance element R02 plus the resistance element R01, so that the resistance value increases, thereby allowing the amplitude of the output signal voltage to be increased corresponding to the voltage of the phantom power supply and allowing the maximum permissible input sound pressure level to the electro-acoustic transducer element 6 to be increased.

As described above, the microphone code is connected to the output circuit of the microphone, and thus a high frequency current is likely to penetrate the microphone code from the outside, and the high frequency current penetrated from the microphone code attempts to penetrate the above-described output circuit. Since the microphone code serves also as the supply path of the phantom power supply, if a switch, which switches the values of the above-described load resistance between when using the phantom power supply and when using the built-in battery power supply, is a switch that is electrically coupled like in the conventional one, then a high frequency current flows into the impedance converter Q01 via this switch, and the high frequency current is detected at the FET 18, which is a basic part of the impedance converter Q01, to thereby cause a noise. In this regard, according to the embodiment of the present invention shown in FIG. 1, since the switch for switching the load resistance elements of the impedance converter Q01 between when using the phantom power supply and when using the built-in battery power supply is the optical switch 10, the electrical coupling between the supply path of the microphone code and phantom power supply and the impedance converter Q01 is cut off by the optical switch 10, so that a high frequency current is prevented from flowing into the impedance converter Q01. Consequently, a noise caused by the high frequency current will not occur in the FET 18 of the impedance converter Q01.

Since the optical switch 10 is a Photo-MOS relay and the phantom power supply is supplied to the power supply line 7 via the LED 11 that is a light emitting element at the input side of the Photo-MOS relay, the LED 11 serves also as a backflow preventing diode that prevents a current from flowing into the phantom power supply circuit side when using the built-in battery power supply 5, and it is thus not necessary to provide a backflow preventing diode, separately.

What is claimed is:

1. A condenser microphone circuit, comprising: a condenser type electro-acoustic transducer element; an impedance converter that converts an output impedance of the electro-acoustic transducer element; a load resistance of the impedance converter; a phantom power supply and a built-in battery power supply for operating the impedance converter; and a switch that switches values of the load resistance between at the time of using the phantom power supply and at the time of using the built-in battery power supply, wherein the switch is an optical switch that turns on/off optical coupling.

2. The condenser microphone circuit according to claim 1, wherein the optical switch is switched so that a value of the load resistance is larger at the time of using the phantom power supply than at the time of using the built-in battery power supply.

3. The condenser microphone circuit according to claim 1, wherein the optical switch is a Photo-MOS relay.

4. The condenser microphone circuit according to claim 2, wherein the phantom power supply is supplied to a light emitting element that constitutes a primary side of the Photo-MOS relay.

5. The condenser microphone circuit according to claim 4, wherein the light emitting element is a light emitting diode and a power supply is supplied to the microphone circuit via the light emitting diode.

6. The condenser microphone circuit according to claim 5, wherein to the light emitting diode, a power supply is supplied from the phantom power supply via a constant current diode.

7. The condenser microphone circuit according to claim 1, wherein the impedance converter includes as its main component a field-effect transistor.
